(19) United States
(12) Patent Application Publication
(10) Pub. No.: US 2022/0297294 A1
(43) Pub. Date: Sep. 22, 2022

(54) ROBOTIC SYSTEM WITH AUTONOMOUS USE OF A MULTI-MODE END EFFECTOR

(71) Applicant: Dexterity, Inc., Redwood City, CA (US)

(72) Inventors: Jeesu Baek, San Mateo, CA (US); Salvador Perez, Jersey City, NJ (US); Andrew Dupree, San Francisco, CA (US); Robert Moreno, Sunnyvale, CA (US); Robert Holmberg, Mountain View, CA (US)

(21) Appl. No.: 17/696,263

(22) Filed: Mar. 16, 2022

Related U.S. Application Data
(60) Provisional application No. 63/162,875, filed on Mar. 18, 2021.

(51) Int. Cl. B25J 9/16; B25J 15/06

(52) U.S. Cl. CPC B25J 9/1653; B25J 9/163; B25J 9/1612; B25J 9/1669; B25J 15/0616

(57) ABSTRACT

A robotic system configured to use a multi-mode end effector is disclosed. In various embodiments, a grasp strategy is determined for a robot to grasp an object in a workspace, wherein the determined grasp strategy is associated with a corresponding one of a plurality of grasping modes of operation of a multi-mode robotic end effector associated with the robot. A command to grasp the object using the multi-mode robotic end effector in the grasping mode of operation associated with the determined grasp strategy is sent to the robot.

### CROSS REFERENCE TO OTHER APPLICATIONS

This application claims priority to U.S. Provisional Patent Application No. 63/162,875 entitled MULTI-MODE ROBOTIC END EFFECTOR filed Mar. 18, 2021 which is incorporated herein by reference for all purposes.

### BACKGROUND OF THE INVENTION

A robotic arm typically is equipped with an “end effector”, such as a suction-based or gripper-type end effector, which the robot uses to grasp objects. For example, a robotic arm may be equipped with a suction cup-based or foam suction pad-based end effector. A robotic control system applies a vacuum under robot control to grasp and object by suction. Or, alternatively, a gripper or other clamping force-based end effector may be provided and used to grasp an object, such as by applying force on the object from two or more sides using an amount of force sufficient to lift the object without slippage while not damaging the object.

Some objects are more capable of being grasped using suction than others. For example, cardboard boxes with smooth, regular (e.g., flat) surfaces may be more easily grasped by suction that objects with less regular surface topography, in particular heavy objects. For example, a case of water bottles or other heavy items enclosed in shrink wrap may be too heavy and/or have too irregular a top or other grasping surface to be grasped using suction. Conversely, a suction-type end effector may be better suited than another type of end effector to grasp other items, such as relatively lighter objects with a flat surface.

### BRIEF DESCRIPTION OF THE DRAWINGS

Various embodiments of the invention are disclosed in the following detailed description and the accompanying drawings.

FIG. 1 is a flow diagram illustrating an embodiment of a process to use a multi-mode end effector in an autonomous mode of robotic operation.

FIG. 2 is a flow diagram illustrating an embodiment of a process to determine a grasp strategy and associated end effector mode(s) of operation.

FIG. 3A is a diagram illustrating an embodiment of a robotic system comprising a multi-mode robotic end effector.

FIG. 3B is a diagram illustrating an embodiment of a robotic system comprising a multi-mode robotic end effector.

FIG. 4A is a diagram illustrating an embodiment of a multi-mode robotic end effector configured to grasp an object in a suction mode of operation.

FIG. 4B is a diagram illustrating an embodiment of a multi-mode robotic end effector configured to grasp an object in a suction mode of operation.

FIG. 4C is a diagram illustrating an embodiment of a multi-mode robotic end effector configured to grasp an object in a clamping mode of operation.

FIG. 4D is a diagram illustrating an embodiment of a multi-mode robotic end effector configured to grasp an object in a clamping mode of operation.

FIG. 5A is a diagram illustrating an embodiment of a multi-mode robotic end effector configured to grasp an object in a suction mode of operation.

FIG. 5B is a diagram illustrating an embodiment of a multi-mode robotic end effector configured to grasp an object in a suction mode of operation.

FIG. 6A is a diagram illustrating an embodiment of a multi-mode robotic end effector configured to grasp an object in a clamping mode of operation.

FIG. 6B is a diagram illustrating an embodiment of a multi-mode robotic end effector configured to grasp an object in a clamping mode of operation.

FIG. 7A is a diagram illustrating an embodiment of a multi-mode robotic end effector configured to grasp an object in a suction mode of operation.

FIG. 7B is a diagram illustrating operation of a linkage set of structures in an embodiment of a multi-mode robotic end effector.

FIG. 7C is a diagram illustrating an embodiment of a multi-mode robotic end effector configured to grasp an object in a clamping mode of operation.

FIG. 7D is a diagram illustrating an embodiment of a multi-mode robotic end effector configured to grasp an object in a clamping mode of operation.

FIG. 8A is a diagram illustrating an embodiment of a multi-mode robotic end effector comprising friction pads for use in a clamping mode of operation.

FIG. 8B is a diagram illustrating an embodiment of a multi-mode robotic end effector comprising friction pads for use in a clamping mode of operation.

FIG. 9A is a diagram illustrating an embodiment of a multi-mode robotic end effector comprising clamping elements that are tilted inward to facilitate grasping in a clamping mode of operation.

FIG. 9B is a diagram illustrating an embodiment of a multi-mode robotic end effector comprising clamping elements that are tilted inward to facilitate grasping in a clamping mode of operation.

FIG. 10A is a diagram illustrating an embodiment of a multi-mode robotic end effector configured to grasp an object in a suction mode of operation.

FIG. 10B is a diagram illustrating an embodiment of a multi-mode robotic end effector configured to grasp an object in a clamping mode of operation.

FIG. 11A is a diagram illustrating an embodiment of a multi-mode robotic end effector configured to grasp an object in a clamping mode of operation.

FIG. 11B is a diagram illustrating a bottom view of suction elements and a clamping element an embodiment of a multi-mode robotic end effector.

FIG. 11C is a diagram illustrating an embodiment of a multi-mode robotic end effector configured to grasp an object in a suction mode of operation.

FIG. 12 is a block diagram illustrating an embodiment of a robotic system configured to autonomously use a multi-mode robotic end effector.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A multi-mode robotic end effector is disclosed. In various embodiments, a multi-mode robotic end effector includes two or more modes of operation. In some embodiments, a multi-mode robotic end effector includes a first mode of operation, in which suction force is used to grasp an object, and a second mode of operation, in which clamping (or other gripping) force is used to grasp an object.

A robotic system that uses a multi-mode robotic end effector is disclosed. The system selects, autonomously, a mode of operation in which to use the end effector to grasp an object. The system uses the end effector in the selected mode of operation to grasp the object. For example, a robotic system as disclosed herein may determine one or more attributes of an object to be grasped, e.g., using cameras, weight sensors, and/or other sensors, and may select a grasp strategy that involves using one or more modes of the end effector to grasp the object. The robotic system places the robotic end effector in the selected mode(s) of operation and uses the end effector to grasp the object, according to the selected grasp strategy.

In various embodiments, a robotic system as disclosed herein may use computer vision, weight sensors, and/or other sensors to perceive and determine the attributes of an object to be grasped, and to select a grasp strategy and corresponding mode(s) of end effector operation to grasp the object. For example, an object determined to have an exposed/accessible surface with a smooth, less porous, and/or less deformable surface large enough to be grasped using a multi-mode gripper in a suction mode of operation may result in selection of a grasp strategy that uses the multi-mode gripper in a suction mode. Conversely, if the attributes of the object are determined to render the suction mode less desirable and/or likely to be successful, e.g., the object has a surface that is uneven, comprises or is wrapped in material that is easy to deform or change shape, is a heavy object that may require a more complete sealing and stronger vacuum to grasp by suction, etc., a grasp strategy that uses the multi-mode gripper in a clamping mode of operation may be (more likely to be) selected.

In various embodiments, a multi-mode robotic end effector as disclosed herein includes structures operable under robotic control to move a first set of structures associated with a first mode of end effector operation to a stowed position, e.g., to configure the end effector to be used in a second mode of operation. For example, structures associated with a suction mode of operation may be retracted, rotated, translated, and/or otherwise moved to a stowed position so as not to interfere with operation and use of the end effector in a second mode of operation, e.g., to grasp, move, and place an item using a clamping force and associated structures. Conversely, the structures associated with the clamping mode of operation may be placed in a stowed position while the structures associated with the first (e.g., suction) mode of operation are deployed and used.

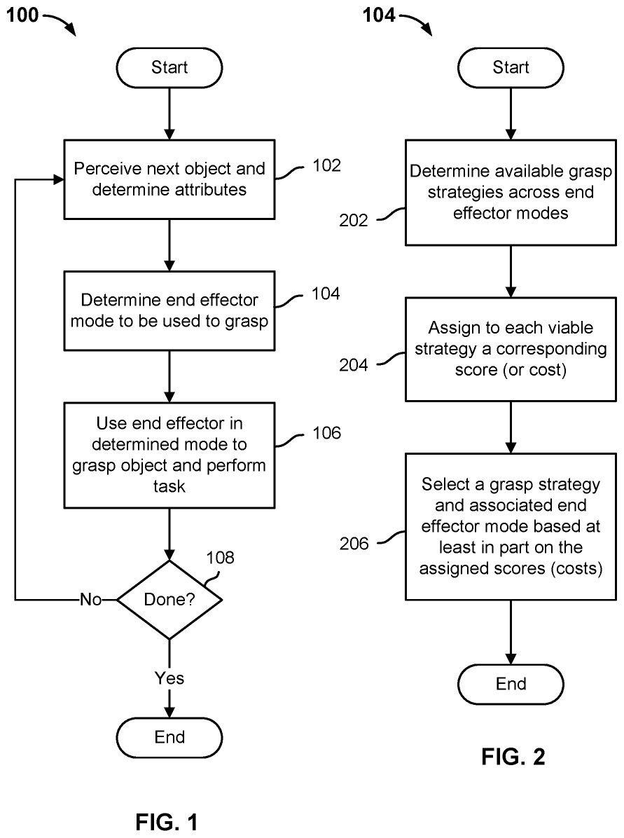

FIG. 1 is a flow diagram illustrating an embodiment of a process to use a multi-mode end effector in an autonomous mode of robotic operation. In various embodiments, the process 100 of FIG. 1 is performed by one or more computers and/or hardware processors. For example, a robotic control system may perform process 100.

In the example shown, at 102 one or more attributes of a next object to be grasped are determined. For example, computer vision may be used to determine an object identity and/or type, and one or more attributes of the object may be determined based on the identification. For example, a bar code or other optical code may be read, and/or an object name, number, or other identifier may be detected and decoded, e.g., in an image of the object. In some embodiments, data sources may be used to identify the object and/or type, e.g., by looking up a number or other identifier read from a label on the object and/or by cross-referencing information from other sources, such as a manifest, invoice, order, or other record or list of objects anticipated to be received and/or handled by the robotic system. In some embodiments, three-dimensional (3D) images may be used to determine the dimensions of the object and its orientation, normal vectors, etc. In some embodiments, computer vision, machine learning, and other techniques may be used to determine attributes of the object, such as whether one or more exposed surfaces of the object are relatively flat or more irregular, whether wrapping or other packaging is rigid or flexible and/or whether such external materials are tightly bound or wrapped, such as shrink wrap, or more loosely wrapped or adhered to the object, such as a poly bag.

At 104, a mode in which to use the multi-mode end effector to grasp the object is determined, autonomously, by the robotic system. In some embodiments, the system chooses a preferred mode of operation, based at least in part on the object attributes (e.g., weight, size, regularity of surfaces, nature of materials, etc.). In some embodiments, the system considers one or more grasp strategies, each of which uses the end effector in one or more corresponding modes of operation, and selects a grasp strategy to be used to grasp the object using the end effector in the one or more corresponding modes of operation.

At 106, the multi-mode end effector is used, in the mode of operation selected or otherwise determined at 104, to grasp the object and perform an associated task, such as moving it to and placing it at a destination location, such as a determined specific location on a pallet or other receptacle. Steps 102, 104, and 106 are repeated, for successive objects, until the system determines at 108 that it is done (for now), e.g., all objects required to be grasped and moved have been placed.

FIG. 2 is a flow diagram illustrating an embodiment of a process to determine a grasp strategy and associated end effector mode(s) of operation. In various embodiments, the process of FIG. 2 is performed to implement step 104 of the process 100 of FIG. 1. In the example shown, at 202 the system determines available grasp strategies across end effector modes of operation. In various embodiments, the system is configured to use machine learning to learn, evaluate, and rate strategies to grasp objects in various end effector modes of operation. In various embodiments, the system uses machine learning to learn to assess the likelihood of success of a given grasp strategy with respect to a given object based in a specific context, based on factors such as the size, dimensions, weight, rigidity, surface regularity (or irregularity), etc., of the object, along with context data such as the orientation of the object and the location and orientation of the object relative to other objects in the workspace (e.g., near a wall or other obstacle, partly obstructed by or entangled with other objects, etc.). In some embodiments, the system is trained, at least in part, by watching a human operator and/or the robotic control system use the end effector in various modes of operation, and/or in some embodiments in various combinations of modes of operation, to grasp a variety of objects having a range of attributes.

At 204, the system assigns to each viable grasp strategy a corresponding score and/or cost. For example, the system may assign to each grasp strategy an associated probability of success, e.g., based on observations made over time as to the success of that strategy in grasping the same object or similar objects. In various embodiments, the system may assign to each of at least a subset of available grasp strategies a corresponding cost to grasp the object using that strategy. For example, for each determined grasp strategy that has greater than a threshold probability of success, the system may determine a corresponding cost by assigning a value to the time; energy; computational, memory or other system resources required to grasp the object using that strategy. A grasp strategy that uses the end effector in a mode of operation in which the end effector is already configured to be used may be assigned a lower cost, for example, than a strategy that would require that the end effector be placed in a different mode of operation, given the costs (time, power, etc.) associated with transitioning the end effector into the other mode of operation.

At 206, the system uses the scores and/or costs determined at 204 to select a grasp strategy and associated end effector mode to be used. For example, the system may select the lowest cost grasp strategy that has at least a threshold score (e.g., probability of success).

In various embodiments, at 202, 204, and/or 206 (or equivalent steps), the system considers available strategies to grasp more than one object and/or different permutations, sequences, and combinations of objects. For example, if multiple objects are available to be grasped in a workspace, the system may consider different sequences to grasp and move them, including by considering efficiencies that may be realized by grasping two or more objects in succession using the end effector in a same mode of operation. For example, the system may determine to use the end effector in a suction mode of operation to grasp and move N items in succession then transition to a clamping mode of operation to grasp and move the next M items. In this way, the system may minimize the collective cost of transitions between end effector modes, such as could occur if the system were to determine end effector modes and grasp strategies for the N+M objects one by one, without regard to which mode the end effector was already in and/or would most helpfully be in for the use to grasp the next object.

In some embodiments, a hierarchical scheduler is used. A lower-level scheduler may determine, evaluate, and select grasp strategies with respect to a given next object to be grasped, while a higher-level scheduler may intervene as/if indicated, e.g., to reorder the sequence in which objects will be grasped to minimize end effector mode transitions, for example.

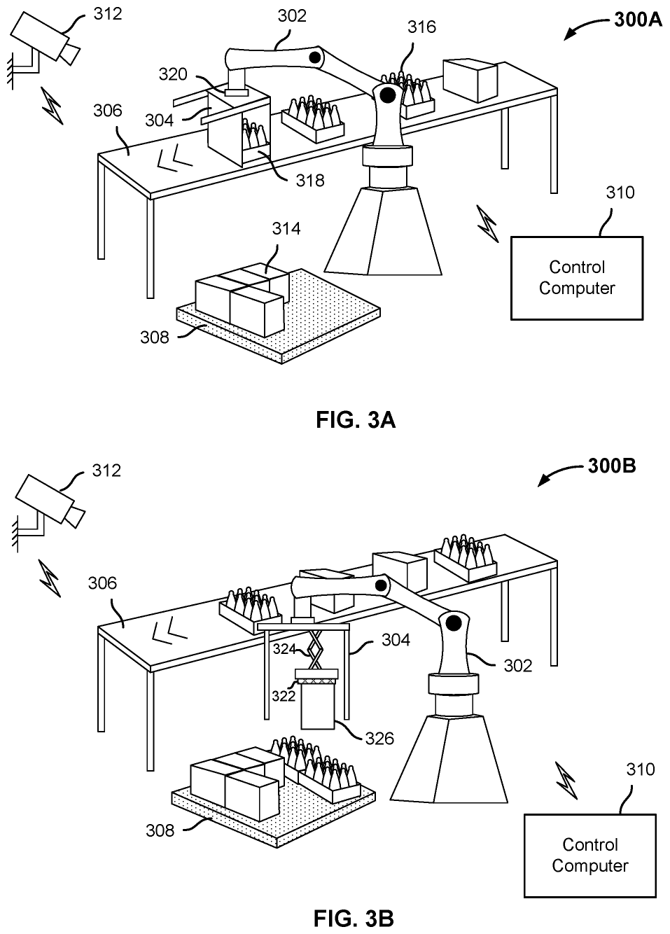

FIG. 3A is a diagram illustrating an embodiment of a robotic system comprising a multi-mode robotic end effector. In the example shown, system and environment 300A includes a robotic arm 302 having a multi-mode end effector 304. The robotic arm 302 and multi-mode end effector 304 are positioned, in this example, to pick objects from a conveyor 306 and place them on a pallet (or other receptacle) 308. The robotic arm 302 and multi-mode end effector 304 are operated in an autonomous mode by a control computer 310. In various embodiments, control computer 310 implements one or both of the processes of FIGS. 1 and 2.

In the example shown in FIG. 3A, control computer 310 is in wireless communication with robotic arm 302 and end effector 304, as well as with camera 312 (and, in some embodiments, other sensors, not shown in FIG. 3A). Control computer 310 sends commands to robotic arm 302 and end effector 304 via wireless communication. For example, control computer 310 may send wireless communications to move the robotic arm 302 into position to grasp objects from conveyor 306. Control computer 310 may send commands to end effector 304 via wireless communications, e.g., to cause the end effector 304 to transform between operating modes (e.g., suction versus clamping) and/or to actuate a selected mode (e.g., apply vacuum to suction elements to use the end effector 304 in suction mode).

In the state shown in FIG. 3A, a number of boxes 314 have been stacked on pallet 308. Due to the regular, flat surfaces of boxes 314, in various embodiments the end effector 304 may have been used in a suction mode of operation to pick the boxes 314 from the conveyor 306 and stack them on the pallet 308, as shown.

In the example shown in FIG. 3A, the control computer 310 has determined, e.g., based on images received via wireless (or other) communications from camera 312, that irregularly shaped objects such as objects 316, 318, in this example cases of bottled water or other liquid, are coming up next on the conveyor 306. The end effector 304 has been placed in a clamping mode of operation, in the example and state as shown, enabling the object 318 to be grasped by clamping its sides. Force sensors in coupling collar 320 may be used, in various embodiments, to position the end effector 304 adjacent to the object 318 and to close the clamping mechanism to grasp the object 318, as shown. The force sensors in collar 320 may be used, in various embodiments, to detect that the object 318 has been grasped successfully and/or to detect any slippage of the object 318 from within the grasp of end effector 304.

FIG. 3B is a diagram illustrating an embodiment of a robotic system comprising a multi-mode robotic end effector. In the example shown in FIG. 3B, the system and environment 300B is shown in a state in which two cases of bottles have been added to the pallet 308 and the end effector 304 has been transitioned to a suction mode of operation by extending a suction mechanism 322 has been extended by scissor linkage 324 to enable a box 326 to be grasped using suction force. In various embodiments, the suction mechanism 322 includes one or more foam-type suction elements and/or one or more silicone or other pliable suction cups, along with a manifold and/or one or more hoses to apply suction (i.e., a vacuum) to the suction elements. In the example shown, a movable clamping panel, shown to the left, of the end effector 304 has been moved to a stowed position to allow for the suction mechanism 322 to be extended, as shown, thus allowing the box 326 to be engaged using suction force.

As FIGS. 3A and 3B illustrate, an autonomous robotic system as disclosed herein, in various embodiments, switches a multi-mode end effector between modes, in this example between a suction mode and a clamping mode, as need to be grasp a given object.

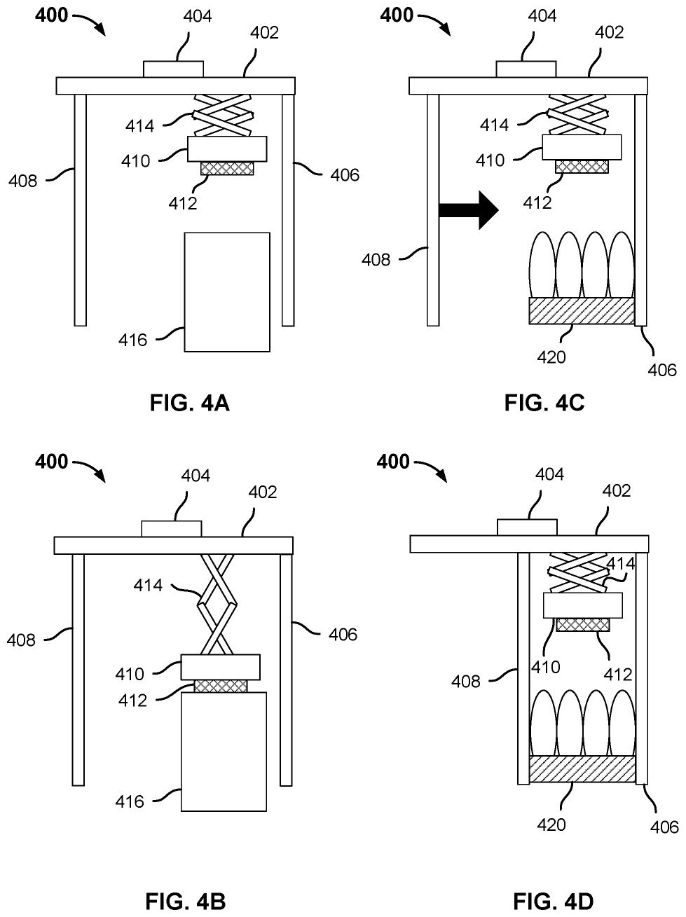

FIG. 4A is a diagram illustrating an embodiment of a multi-mode robotic end effector configured to grasp an object in a suction mode of operation. In the example shown, multi-mode end effector 400 is shown preparing to transition to a suction mode of operation. The multi-mode end effector 400 includes a cross member 402 configured to be attached to a robotic arm via a force sensor-equipped coupler/collar 404. The end effector 400 includes side panels 406 and 408 associated with a clamping mode of operation. In this example side panel 406 is statically coupled to cross member 402 while side panel 408 is movable. For example, side panel 408 may be moved by one or more linear actuators (not shown in FIG. 4A) housed in cross member 402. In the state as shown in FIG. 4A, the side panel 408 has been moved to a stowed or fully open position, to the left as shown, to make room for the structures associated with the suction mode of operation to be deployed, in this example a suction manifold or body 410 and foam suction pad 412 configured to be deployed by extending scissor linkage 414 to enable a box 416 to be engaged in the suction mode.

FIG. 4B is a diagram illustrating an embodiment of a multi-mode robotic end effector configured to grasp an object in a suction mode of operation. In the state as shown in FIG. 4B, the suction mechanism 410, 412 has been extended, by operation (under robotic control) of scissor linkage 414, e.g., using actuators (not shown in FIG. 4B) housed in cross member 402. The suction mechanism 410, 412 has been actuated, e.g., by applying a vacuum to pad 412, to engage and grasp the box 416.

FIG. 4C is a diagram illustrating an embodiment of a multi-mode robotic end effector configured to grasp an object in a clamping mode of operation. In the example and state shown in FIG. 4C, the suction mechanism 410, 412 has been retracted to the stowed position as shown, e.g., by operation (under robotic control) of scissor linkage 414 using actuators (not shown in FIG. 4C) housed in cross member 402. The robotic arm (not shown) has been moved to position the stationary side panel 406 adjacent to a first side of object 420. The movable side panel 408 is being moved to the right, as indicated by the arrow in FIG. 4C, to engage the opposite side of object 420 in a clamping motion. For example, force control based on forces sensed by sensors in collar 404 may have been used to position the end effector 400 such that the side panel 406 of end effector 400 is engaged with the first side of object 420, as shown.

FIG. 4D is a diagram illustrating an embodiment of a multi-mode robotic end effector configured to grasp an object in a clamping mode of operation. In the example and state shown in FIG. 4D, the suction mechanism 410, 412 remains retracted, providing clearance to enable the object 420 to be grasped by clamping between the side panels 406, 408 of end effector 400.

In various embodiments, a robotic system as disclosed herein may have placed the end effector 400 in the clamping mode shown in FIGS. 4C and 4D, e.g., by using image and/or other sensor information to determine that the object 420 would best be grasped using the clamping mode shown in FIGS. 4C and 4D, as opposed to the suction mode illustrated in FIGS. 4A and 4B. For example, in some embodiments, the robotic system may have detected the irregular topology of the top surface of object 420 and/or may have determined based on one or more attributes of object 420, such as its weight, that the clamping mode of operation should be used.

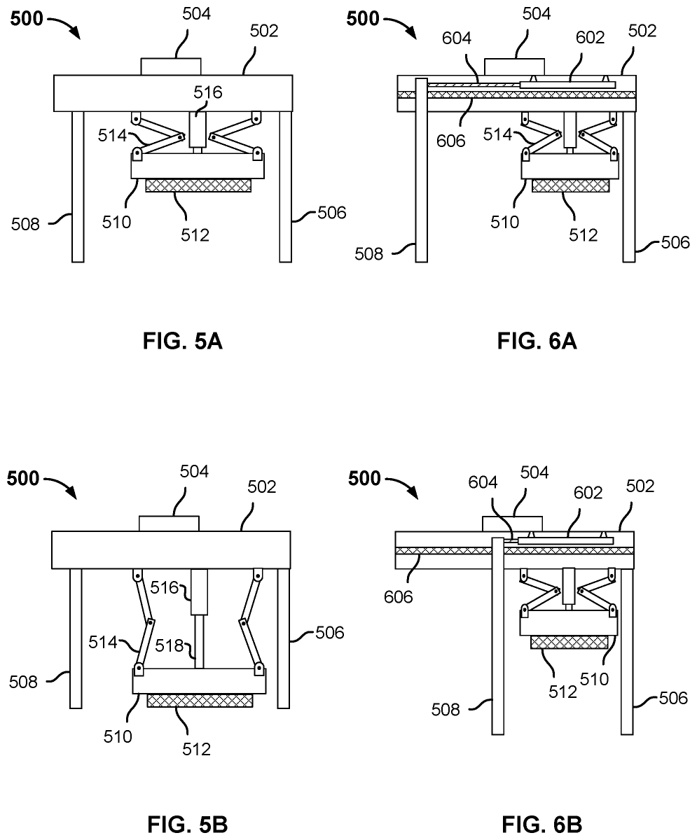

FIG. 5A is a diagram illustrating an embodiment of a multi-mode robotic end effector configured to grasp an object in a suction mode of operation. In the example shown, end effector 500 includes a cross member 502 and a coupling collar 504 to couple the end effector to a robotic arm (not shown). End effector includes side panels 506 and 508, which are stowed in an open position in the state shown in FIG. 5A, to allow room for the suction mechanism body 510 and foam suction pad(s) 512 to be extended by extending scissor linkage 514 by operation of actuator 516, such as a pneumatic or other piston.

FIG. 5B is a diagram illustrating an embodiment of a multi-mode robotic end effector configured to grasp an object in a suction mode of operation. In the state shown in FIG. 5B, piston rod 518 has been extended out from cylinder 516, e.g., by applying pneumatic pressure to an opposite (upper) side of a piston within cylinder 516, causing the suction mechanism body 510 and foam suction pad(s) 512 to be lowered and the scissor linkage 514 to be extended, as shown. In the state shown, the suction pad(s) 512 extend below a bottom edge of panels 506, 508, enabling a surface of an object (not shown in FIG. 5B) to be engaged by suction.

FIG. 6A is a diagram illustrating an embodiment of a multi-mode robotic end effector configured to grasp an object in a clamping mode of operation. In the example shown, the suction mode-related elements 510, 512, 514 of end effector 500 have been retracted into the stowed position as shown. FIG. 6A includes a partial cutout view of the cross member 502, which reveals that in the embodiment shown the cross member 502 includes a linear actuator 602 and associated extendable and retractable rod 604 configured to move the side panel 508 along a guide rail 606, e.g., to perform a clamping operation under robotic control. Examples of a linear actuator 602 include, without limitation, a pneumatic piston, a rack and pinion mechanism, a linear bearing, and/or other mechanical, electro-mechanical, hydraulic, pneumatic and/or piezoelectric linear actuators.

FIG. 6B is a diagram illustrating an embodiment of a multi-mode robotic end effector configured to grasp an object in a clamping mode of operation. In the state shown in FIG. 6B, the end effector 500 is shown in a state in which the linear actuator 602, 604 has been used to move the side panel 508 to the right, relative to the position as shown in FIG. 6B, e.g., to grasp an object (not shown) in a clamping mode of operation. In various embodiments, force sensors coupled to side panel 508 may be used to monitor the force being applied to the object via clamping and to control the linear actuator 602, 604, under robotic control, to apply a desired amount of force. In various embodiments, the desired force is calculated to ensure a sufficient force of friction between the side panels 506, 508 and the object to enable the object to be lifted and moved without slippage while avoiding the application of excessive clamping force, which could damage the object. In various embodiments, the clamping force sufficient to lift the object yet not so great as to cause damage is determined dynamically by the robotic system, e.g., based on an identification and/or classification of the object, such as an identification and/or classification determined based on image and/or other sensor information.

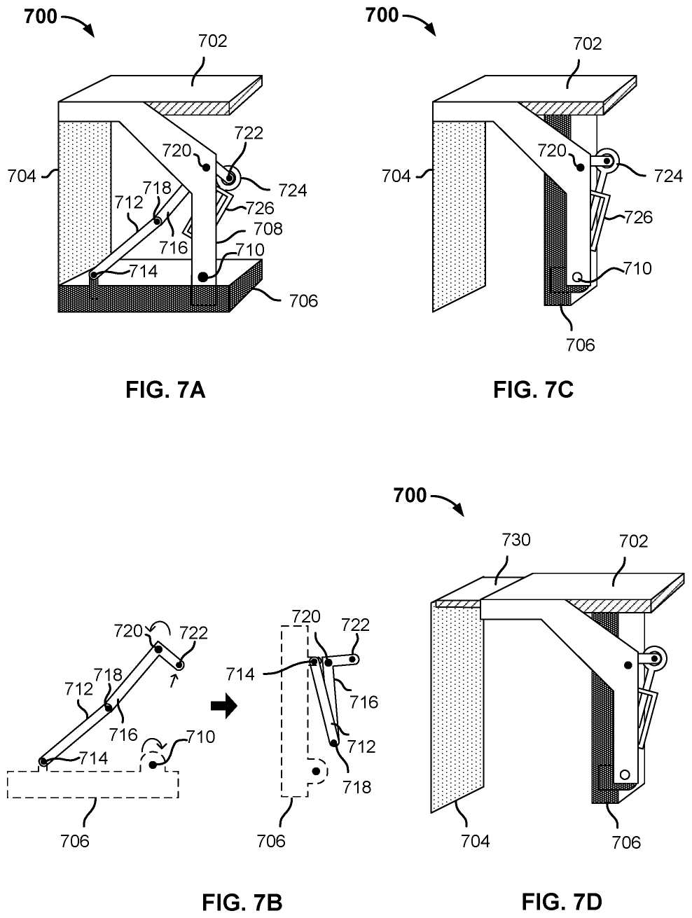

FIG. 7A is a diagram illustrating an embodiment of a multi-mode robotic end effector configured to grasp an object in a suction mode of operation. In the example shown, end effector 700 includes a top member 702 and a side panel 704. A suction mechanism 706, shown in FIG. 7A in a deployed position associated with a suction mode of operation, includes one or more suction elements, such as foam suction elements, on a bottom face of the suction mechanism 706. The suction mechanism 706 includes and/or has associated therewith structures to apply a vacuum to the suction elements comprising suction mechanism 706, such as electrically controlled valves and air hoses (not shown in FIG. 7A).

Referring further to FIG. 7A, the end effector 700 includes structures to support suction mechanism 706 and structures configured to extend the suction mechanism 706, e.g., into the position as shown in FIG. 7A, or, alternatively, to retract the suction mechanism 706 into a stowed position associated with a clamping mode of operation of end effector 700, as described more fully below. The support structures include a bracket 708 and a pin 710. The suction mechanism 706 is rotatably mechanically coupled to the bracket 708 by the pin 710. The bracket 708 is coupled mechanically to the top member 702 in a fixed position relative to top member 702.

The extension/retraction structures shown in FIG. 7A include a linkage comprising a straight link 712 coupled rotatably to the suction mechanism by pin 714, and an “L” shaped link 716 coupled rotatably to the link 712 by pin 718 and coupled rotatably to bracket 708 by pin 720. A distal end of “L” shaped link 716 is coupled rotatably by pin 722 to a connector 724 on a distal end of a rod comprising linear actuator 726. Linear actuator 726, in various embodiments, may be any linear actuator, e.g., as mentioned above, and in various embodiments is operated under robotic control to configure the end effector to operate in a suction mode of operation, e.g., as shown in FIG. 7A, or to instead configure end effector 700 to operate in a clamping mode of operation, as described below.

FIG. 7B is a diagram illustrating operation of a linkage set of structures in an embodiment of a multi-mode robotic end effector. On the left side of FIG. 7B, the extension/retraction structures shown in FIG. 7A, i.e., links 712, 716 and pines 714, 718, 722, are shown in the relative positions associated with deployment and use of the suction mechanism 706, e.g., as shown in FIG. 7A. One the right side of FIG. 7B, the same structures are shown in their relative positions when the suction mechanism 706 is in the upright/stowed position associated with a clamping mode of operation. For example, to place the linkage structures in the positions as shown on the right side of FIG. 7B, in various embodiments, the linear actuator 726 may have been operated under robotic control, causing the rod 724 to extend out from the body/cylinder of linear actuator 726, in turn causing the “L” shaped link 716 to rotate about pin 720 into the position as shown, which in turn caused the other elements of the linkage to be pulled/rotated into the positions as shown.

FIG. 7C is a diagram illustrating an embodiment of a multi-mode robotic end effector configured to grasp an object in a clamping mode of operation. In various embodiments, the position of the structures comprising end effector 700, as shown in FIG. 7C, corresponds to the relative positions of the linkage structures as shown in the right side of FIG. 7B, with some of the relevant structures being obscured by bracket 708 in the view as shown in FIG. 7C.

In various embodiments, the actuator 726 is actuated under robotic control to cause the suction mechanism 706 and associated structures to be rotated into the position as shown in FIG. 7C to place the end effector 700 in a clamping mode of operation. In this example, the suction mechanism 706, in the position as shown in FIG. 7C, is used as a non-moving side panel to perform a clamping operation in which an object (not shown in FIG. 7C) is clamped between the side panel 704 and the opposite surface of suction mechanism 706.

FIG. 7D is a diagram illustrating an embodiment of a multi-mode robotic end effector configured to grasp an object in a clamping mode of operation. In the state shown in FIG. 7D, the side panel 704 has been extended by an extender/pusher structure 730, e.g., by operation of one or more actuators (not shown) housed within top by member 702. For example, the side panel 704 may be pushed to the “open” position shown in FIG. 7D under robotic control, to open the distance between the opposite surfaces of side panel 704 and suction mechanism 706, as shown, such as to create an opening large enough to accommodate a box or other object to be grasped by using end effector 700 in the clamping mode of operation.

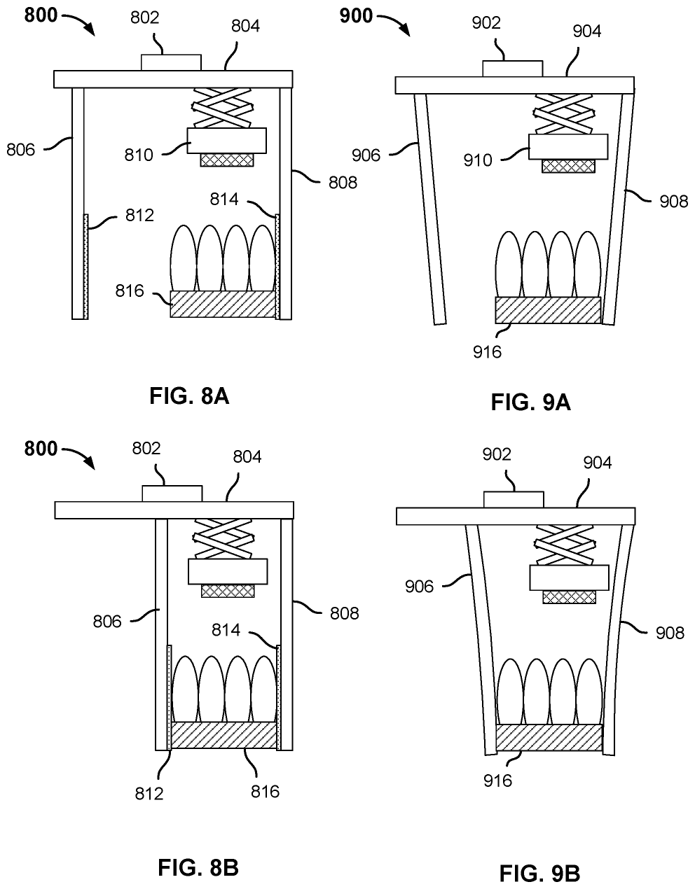

FIG. 8A is a diagram illustrating an embodiment of a multi-mode robotic end effector comprising friction pads for use in a clamping mode of operation. In the example shown, end effector 800 includes a coupling collar 802, a cross member 804, a movable side panel 806 movably mounted to cross member 804, and a stationary side panel 808 fixedly mounted to cross member 804. In the state shown, a suction mechanism 810 is shown in a retracted/stowed position. The end effector 800 includes friction pads 812, 814 mounted on the interior faces of the side panels 806, 808. The friction pads 812, 814 comprise materials with a relatively higher coefficient of friction, e.g., relative to the surfaces of side panels 806, 808. In various embodiments, the relatively higher coefficient of friction of friction pads 812, 814 allows an object, such as object 816, to be grasped in a clamping mode while allowing a lesser amount of clamping force to be applied than would otherwise be required to achieve the force of friction needed to safely lift and move the object 816.

FIG. 8B is a diagram illustrating an embodiment of a multi-mode robotic end effector comprising friction pads for use in a clamping mode of operation. In the state shown in FIG. 8B, the movable side panel 806 has been moved to the right, as shown, e.g., by operation under robotic control of an actuator housed in cross member 804 (not shown), so as to clamp the object 816 between the side panels 806, 808 and the friction pads 812, 814 mounted thereon.

FIG. 9A is a diagram illustrating an embodiment of a multi-mode robotic end effector comprising clamping elements that are tilted inward to facilitate grasping in a clamping mode of operation. In the example shown, end effector 900 includes coupling collar 902, cross member 904, and side panels 906 and 908. A suction mechanism 910 is shown in a retracted/stowed position, to enable object 916 to be grasped in a clamping mode of operation. In the example shown, side panels 908 and 910 are mounted to cross member 904 at inward-pointing angles, to facilitate engagement of objects such as object 916 in the clamping mode of operation. In some embodiments, angling of the side panels 906, 908 enables the object 916 to be engaged initially and/or more substantially with the lower sides of the object 916, which for a given object may present a more regular, rigid, stable, and/or otherwise more graspable surface, as in the example shown. In some embodiments, angling of the side panels 906, 908 enables the object 916 to be engaged at the lower ends of panels 906, 908 while leaving more room between the panels 906, 908 at the upper end, where they are mounted to cross member 904, which in some embodiments allows more room to avoid contact with the suction mechanism 910.

FIG. 9B is a diagram illustrating an embodiment of a multi-mode robotic end effector comprising clamping elements that are tilted inward to facilitate grasping in a clamping mode of operation. In the example shown, side panel 906 has been moved to the right to clamp the object 916 between the side panels 906, 908. In this example, the side panels 906, 908 are made of flexible material, such as sheet metal of a prescribed composition and thickness, selected to have sufficient strength without excessive weight and to allow a desired degree of flexibility, e.g., to enable the inward-angled side panels 906, 908 to bend inward slightly, as shown, with the application of greater force, to controllably increase (e.g., as needed to avoid or halt slippage) the surface area of engagement between the side panels 906, 908 and the object 916.

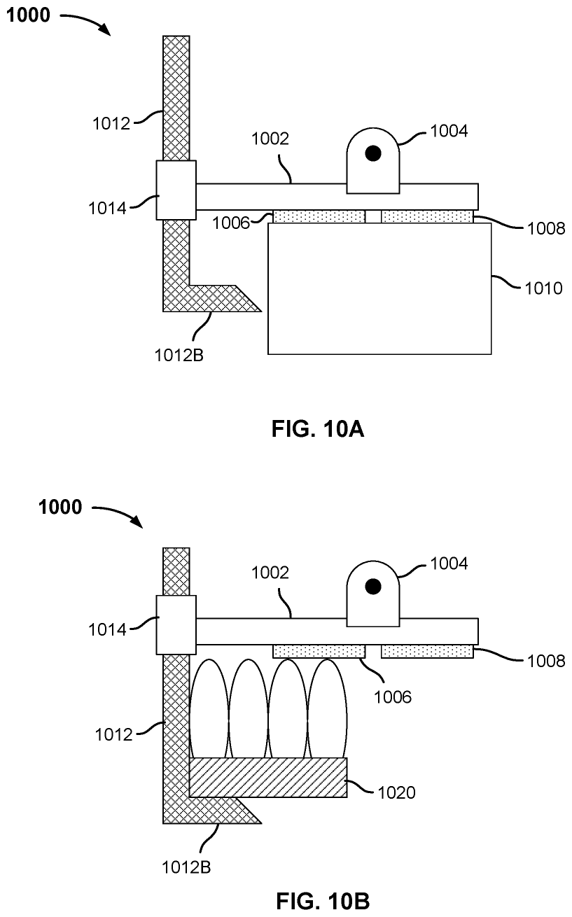

FIG. 10A is a diagram illustrating an embodiment of a multi-mode robotic end effector configured to grasp an object in a suction mode of operation. In the example shown, the end effector 1000 includes a cross member 1002 and mounted point 1004. In the state shown, end effector 1000 is configured in a suction mode of operation, in which suction pads 1006, 1008 are used to grasp object 1010. In the state shown, a clamping member 1012 comprising a horizontal clamping mechanical interface 1012B has been raised up and out of the way by operation, under robotic control, of a linear bearing (or other motive force/actuator) 1014.

FIG. 10B is a diagram illustrating an embodiment of a multi-mode robotic end effector configured to grasp an object in a clamping mode of operation. In the state shown in FIG. 10B, the linear bearing 1014 has been operated to lower the clamping member 1012 to allow the object 1020 to be grasped by clamping the object 1020 between the lower face of the cross member 1002 and suction pad 1006 and the upper surface of the horizontal clamping mechanical interface 1012B portion of clamping member 1012.

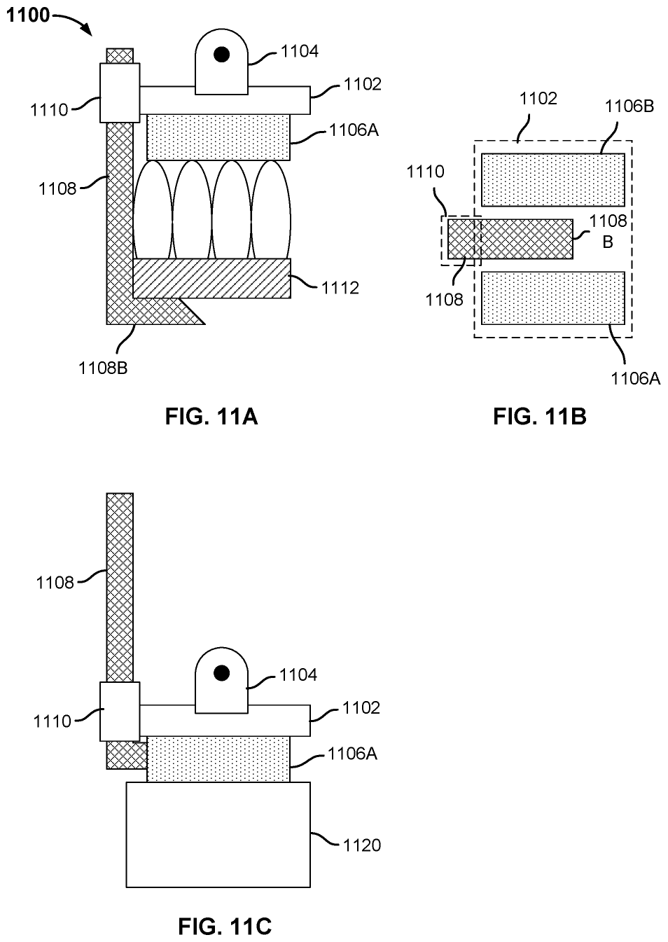

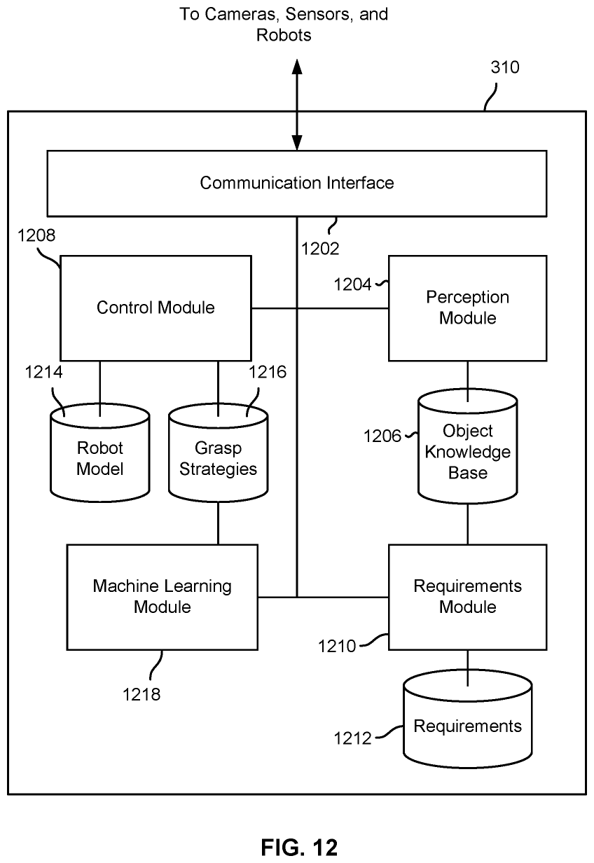

FIG. 11A is a diagram illustrating an embodiment of a multi-mode robotic end effector configured to grasp an object in a clamping mode of operation. Like the example shown in FIGS. 10A and 10B, the end effector 1100 of FIG. 11A includes structures to clamp an object between horizontal members. In this example, end effector 1100 include cross member 1102 and attachment point 1104. A first suction pad 1106A is visible from the angle shown in FIG. 11A. The end effector 1100 further includes a clamping member 1108 having a horizontal clamping mechanical interface 1108B. In the state shown in FIG. 11A, the clamping member 1108 has been moved into the position shown by operation, under robotic control of linear bearing 1110. In some embodiments, linear bearing 1110 is operated, under robotic control, to apply a clamping force to the object 1112, pressing the object 1112 up and into the friction pad 1106A.

FIG. 11B is a diagram illustrating a bottom view of suction elements and a clamping element an embodiment of a multi-mode robotic end effector. In the example and view shown, the end effector 1100 is shown to include two foam suction pads 1106A and 1106B spaced apart by a gap wide enough to accommodate the horizontal clamping mechanical interface 1108B of clamping member 1108.

FIG. 11C is a diagram illustrating an embodiment of a multi-mode robotic end effector configured to grasp an object in a suction mode of operation. In the state shown in FIG. 11C, the linear bearing 1110 has been operated, under robotic control, to lift the clamping member 1108 up, resulting in in the horizontal clamping mechanical interface 1108B of clamping member 1108 being pulled up and into the gap between the foam suction pads 1106A, 1106B, enabling the pads to engage the top surface of object 1120 to grasp object 1120 using the end effector 1100 in a suction mode of operation, as shown.

FIG. 12 is a block diagram illustrating an embodiment of a robotic system configured to autonomously use a multi-mode robotic end effector. In the example shown, the control computer 310 of FIGS. 3A and 3B is shown to include a communication interface 1202, such as a wireless or other network communication interface, coupled to a perception module 1204, a control module 1208, a requirements module 1210, and a machine learning module 1218. In various embodiments, a control computer such as control computer 310 may include more or fewer modules than the perception module 1204, control module 1208, requirements module 1210, and machine learning module 1218 of FIG. 12. In various embodiments, each of perception module 1204, control module 1208, requirements module 1210, and machine learning module 1218 of FIG. 12 may comprise one or more functional processing entities provided at least in part by executing associated computer instructions on one or more processors comprising the control computer 310.

In the example shown, perception module 1204 receives sensor data (e.g., image data from one or more cameras) via the communication interface 1202 and constructs a three-dimensional view of the workspace in which a robotic system controlled by control computer 310 is physically present and operates. The perception module 1204 performs computer vision processing, e.g., segmentation, to discern objects in the workspace and uses an object knowledge base 1206 to identify an object as comprising a specific object and/or type of object and/or to determine one or more relevant attributes of an object, such as the object dimensions, rigidity, fragility, weight, external package materials and/or packaging attributes, and the like.

In various embodiments, control module 1208 uses high level objectives identified by requirements module 1210 and a dynamically updated and evolved view of the workspace and objects therein as perceived by perception module 1204 to determine and update plans and strategies to grasp, move, and place items within the workspace to achieve the high level objectives. The requirements module 1210 uses data in a requirements data store 1212, such as manifests, orders, invoices, or other sets of data, to determine and fulfill requirements.

To perform specific component tasks, such as to grasp, move, and place a given object, the control module 1208 uses state information (e.g., view of the workspace and objects therein, current location and pose of the robotic arm or other robot, etc.) and a model 1214 of the robot (e.g., it geometry, ranges of motion, achievable poses, commands or sequences of commands to move from a current pose to a desired or target pose and/or end effector position, mode of operation, and orientation, etc.) along with a data store 1216 of grasp strategies to grasp generic and/or specific objects or types of objects.

The grasp strategies 1216, in this example, are learned and/or updated dynamically (e.g., continuously, periodically, etc.) by machine learning module 1218. For example, machine learning module 1218 may be used to “train” a grasp strategy model or other representation of learned grasp strategies stored in grasp strategies data store 1216. The observed success or failure of different strategies, in different end effector modes of operation, to grasp a set of objects, e.g., in a learning or training phase of operation, may be used in a later operational mode of operation to select one or more grasp strategies to grasp a given object, in a given context, and to assess one or both of a probability of a successful grasp being made using that strategy and a set of one or more costs associated with using that strategy to grasp that object in that context. The above information is considered by the control module 1208, in various embodiments, to select and use a grasp strategy to attempt to grasp the object, in an associated end effector mode of operation, as in the processes of FIGS. 1 and 2.

In various embodiments, techniques disclosed herein are used to efficiently and effectively pick and place a variety of objects having different attributes, including by a using a multi-mode end effector in a mode of operation (best) suited to the task of grasping a given object, for example as determined in a fully autonomous mode by a robotic control system as disclosed herein.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a communication interface; and
a processor coupled to the communication interface and configured to:
determine a grasp strategy to grasp an object in a workspace, wherein the determined grasp strategy is associated with a corresponding one of a plurality of grasping modes of operation of a multi-mode robotic end effector; and
send to a robot with which the multi-mode robotic end effector is associated a command to grasp the object using the multi-mode robotic end effector in the grasping mode of operation associated with the determined grasp strategy.

2. The system of claim 1, wherein the processor is further configured to receive via the communication interface sensor data associated with the object in the workspace; and determine the grasp strategy to grasp the object based at least in part on the sensor data.

3. The system of claim 2, wherein the processor is configured to use the sensor data to determine the grasp strategy at least in part by using the sensor data to determine an attribute of the object and using the attribute to determine the grasp strategy.

4. The system of claim 1, wherein the multi-mode robotic end effector is configured to respond to the command at least in part by transitioning into a configuration associated with the grasping mode of operation associated with the determined grasp strategy.

5. The system of claim 4, wherein the grasping mode of operation associated with the determined grasp strategy comprises a first mode of operation and the multi-mode robotic end effector is configured to transition into the configuration associated with the first mode of operation at least in part by retracting a mechanism associated with a second mode of operation of the end effector.

6. The system of claim 1, wherein the processor is configured to use machine learning techniques to determine the grasp strategy.

7. The system of claim 1, wherein the processor is further configured to determine the grasp strategy at least in part by determining a set of available grasp strategies, assigning a score to each of at least a subset of grasp strategies in the set, and selecting a selected grasp strategy based at least in part on the assigned scores.

8. The system of claim 1, wherein the determined grasp strategy is associated with a suction mode of operation of the end effector and the processor is configured to determine the determined grasp strategy at least in part based on an attribute of the object associated with the suction mode of operation.

9. The system of claim 8, wherein the attribute is associated with one or both of a weight of the object and a degree of regularity of a surface of the object to be grasped by suction.

10. The system of claim 1, wherein the determined grasp strategy is associated with a clamping mode of operation of the end effector and the processor is configured to determine the determined grasp strategy at least in part based on an attribute of the object associated with the clamping mode of operation.

11. The system of claim 10, wherein the attribute is associated with one or both of a weight of the object and a degree of regularity of a surface of the object to be grasped by suction.

12. The system of claim 1, wherein the processor is further configured to determine the determined grasp strategy based at least in part on a cost associated with the determined grasp strategy.

13. The system of claim 12, wherein the cost reflects a transition cost associated with placing the end effector in the grasping mode of operation associated with the determined grasp strategy

14. The system of claim 1, wherein the processor is further configured to send to the end effector, via the communication interface, a command to place the end effector in the grasping mode of operation associated with the determined grasp strategy.

15. The system of claim 1, wherein the processor is further configured to select the determined grasp strategy based at least in part on a determination that the multi-mode robotic end effector is already in the grasping mode of operation associated with the determined grasp strategy.

16. A method, comprising:
determining a grasp strategy for a robot to grasp an object in a workspace, wherein the determined grasp strategy is associated with a corresponding one of a plurality of grasping modes of operation of a multi-mode robotic end effector associated with the robot; and
send to the robot with which the multi-mode robotic end effector is associated a command to grasp the object using the multi-mode robotic end effector in the grasping mode of operation associated with the determined grasp strategy.

17. The method of claim 16, further comprising receiving via a communication interface sensor data associated with the object in the workspace; and determining the grasp strategy to grasp the object based at least in part on the sensor data.

18. The method of claim 17, wherein the grasp strategy is determined at least in part by using the sensor data to determine an attribute of the object and using the attribute to determine the grasp strategy.

19. The method of claim 16, wherein the multi-mode robotic end effector is configured to respond to the command at least in part by transitioning into a configuration associated with the grasping mode of operation associated with the determined grasp strategy.

20. A computer program product embodied in a non-transitory computer readable medium, comprising computer instructions for:
determining a grasp strategy for a robot to grasp an object in a workspace, wherein the determined grasp strategy is associated with a corresponding one of a plurality of grasping modes of operation of a multi-mode robotic end effector associated with the robot; and
send to the robot with which the multi-mode robotic end effector is associated a command to grasp the object using the multi-mode robotic end effector in the grasping mode of operation associated with the determined grasp strategy.
